(19) United States
(12) Patent Application Publication
(10) Pub. No.: US 2016/0362829 A1
(43) Pub. Date: Dec. 15, 2016

(54) DEVICE FOR DRYING LAUNDRY

(71) Applicant: LG ELECTRONICS INC., Seoul (KR)

(72) Inventors: Kiwook JUNG, Seoul (KR); Haeyoon JE, Seoul (KR)

(21) Appl. No.: 15/177,508

(22) Filed: Jun. 9, 2016

(30) Foreign Application Priority Data
Jun. 9, 2015 (KR) 10-2015-0081047

(51) Int. Cl. D06F 58/20; F25B 41/00; F16L 13/14

(52) U.S. Cl. CPC D06F 58/206; F16L 13/14; F25B 41/003

(57) ABSTRACT

A device for drying laundry includes a refrigerant pipe made of a first metal material that injects a refrigerant into a heat exchanger or discharges a refrigerant from a heat exchanger and a heat exchanger having a pipe type connecting portion made of a second metal material different from the first metal material connected to the refrigerant pipe, a diameter of an end portion from the end of one of the connecting portion and the refrigerant pipe to a predetermined length A is enlarged and thus have arriving portions having a concavely obtuse angle formed an inner diameter surface thereof, and an end portion of the other one of the connecting portion and the refrigerant pipe is inserted into the enlarged diameter and is latched to the arriving portion, and the device includes a lock ring that encloses an external diameter surface of the end portion having the enlarged diameter and presses an inner diameter surface of the end portion having an enlarged diameter and an external diameter surface of the inserted end portion.

### CROSS-REFERENCE TO RELATED APPLICATION

This application claims priority under 35 U.S.C. §119 and 35 U.S.C. §365 to Korean Patent Application No. 10-2015-0081047, filed in Korea on Jun. 9, 2015, whose entire disclosure is hereby incorporated by reference in its entirety.

### BACKGROUND

1. Field

A device for drying laundry, and more particularly, a device for drying laundry including a structure that mechanically connects a heat exchanger and a refrigerant pipe using a lock ring is disclosed herein.

2. Background

Devices for drying laundry supply heated air (or hot wind) to the laundry to dry the laundry. In order to supply the heated air to the laundry, the device for drying the laundry heats air using an electric heater or a condenser.

A drying system of the device for drying the laundry may be classified according to a method of processing air in which heat exchange with the laundry is performed. The drying system may include an exhaust type drying system that discharges air supplied to the laundry, a circulation type drying system that resupplies air to the laundry, and a hybrid drying system that discharges a portion of the air and that circulates the remaining portions.

Humidity of air in which heat exchange with the laundry is performed is very high. Therefore, in the circulation type dry system and the hybrid dry system, a process of condensing a vapor of the air is required. A system that cools air for condensation may be classified into an air cooling type system, a water cooling type system, and a system using an evaporator.

A condenser and evaporator provided in the device for drying the laundry may exchange a heat with air in the following system. A refrigerant, having passed through a compressor may be injected into the condenser to emit a heat and the refrigerant, having passed through an expansion valve via the condenser may be injected into the evaporator to absorb heat. The refrigerant, having passed through the evaporator, may again be injected into the compressor. The compressor, the condenser, the expansion valve, and the evaporator may be connected by the refrigerant pipe.

When connecting the refrigerant pipe and a connecting portion of the condenser and evaporator by welding, an inferiority rate of a bonding portion may increase and thus a possibility in which refrigerant leakage may occur may increase. Particularly, when a material of the refrigerant pipe and the connecting portion of the heat exchanger is different, a refrigerant leakage possibility may further increase.

### BRIEF DESCRIPTION OF THE DRAWINGS

FIG. is a perspective view illustrating a state before a connecting portion of a heat exchanger, a refrigerant pipe, and a lock ring are assembled.

FIG. 2 is a conceptual diagram illustrating a cross-section in which a diameter of an end portion of any one of a connecting portion and a refrigerant pipe is enlarged and in which the ends are latched to arriving portions of one, as an end portion of the other one is inserted into the enlarged diameter.

FIG. 3 is a conceptual diagram illustrating a cross-section in which a diameter of an end portion of any one of a connecting portion and a refrigerant pipe is enlarged and in which the ends are latched to arriving portions of one, as an end portion of the other one having a reduced diameter is inserted into the enlarged diameter.

FIG. 4 is a side view illustrating a state after a connecting portion, a refrigerant pipe, and a lock ring are assembled.

FIG. 5 is a side cross-sectional view taken along a surface including a center line of the refrigerant pipe of FIG. 4.

FIG. 6 is a side cross-sectional view illustrating a change of the connecting portion and the refrigerant pipe according to installation of the lock ring of FIG. 4.

### DETAILED DESCRIPTION

Referring to FIG. 1, a washing machine may include a condenser and evaporator, which collectively are a heat exchanger 1 through which a refrigerant passes. The washing machine may include a refrigerant pipe 20 made of a first metal material (any one metal material) that guides a refrigerant into the heat exchanger 1 or discharges a refrigerant from the heat exchanger 1. In the heat exchanger 1, the pipe type connecting portion 10 made of a second metal material (another metal material) different from the first metal material connected to the refrigerant pipe 20 may be provided.

The refrigerant pipe 20 may connect a compressor and the condenser in order to inject a refrigerant that passes through the compressor into the condenser and connects the condenser and an expansion valve in order to inject a refrigerant that passes through the condenser into the expansion valve. Further, the refrigerant pipe 20 may connect the expansion valve and the evaporator in order to inject a refrigerant that passes through the expansion valve into the evaporator and connect the evaporator and the compressor in order to inject a refrigerant that passes through the evaporator into the compressor. On a connection flow channel by the refrigerant pipe, other elements that can be added by a person of ordinary skill in the art may be included.

The heat exchanger 1 may have a heat exchange pipe and a heat dissipating fin that enable air and a refrigerant to exchange a heat. At both ends of the heat exchange pipe, the connecting portions 10 may be formed. The connecting portion 10 may be integrally formed with the heat exchange pipe and may be coupled to both ends of the heat exchange pipe as a separate component.

Two connecting portions 10 may be provided in one heat exchanger. The connecting portion 10 may be connected to the refrigerant pipe 20 in order to inject a refrigerant into the heat exchanger or may be connected to the refrigerant pipe 20 in order to discharge a refrigerant from the heat exchanger. Further, in the washing machine, because two heat exchangers may be provided as a condenser and an evaporator, a total of four connecting portions 10 may be provided. The present embodiment is applied to at least one of the four portions.

The refrigerant pipe 20 may be made of a first metal material. The first metal material may be any one of Al and Cu, but in the present exemplary embodiment, the first metal material may be Cu.

The connecting portion 10 may be made of the second metal material. The second metal material may be any one of Al and Cu. Because the second metal material may be different from the first metal material, when the first metal material is Al or Cu, the second metal material may be Cu or Al.

A mechanical connection of the connecting portion 10 and the refrigerant pipe 20 made of a different material are described as follows. A diameter of an end portion of a range from the end of any one of the connecting portion 10 and the refrigerant pipe 20 to the predetermined length A may be enlarged. Accordingly, at an inner diameter surface of a location separated by the predetermined length A from the end of the connecting portion 10 or the refrigerant pipe 20, the arriving portions 15 and 25 may be concavely formed in an obtuse angle. The meaning ‘angle’ is a concept including a range from a corner to a bent curve.

An end portion of the other one of the connecting portion 10 and the refrigerant pipe 20 is inserted into an end portion of the one. Accordingly, the end of the other one may be latched to and received in the arriving portions 15 and 25.

The washing machine may include a lock ring 30 that encloses an external diameter surface of an end portion having an enlarged diameter. The lock ring 30 may press an external diameter surface of the end portion having an enlarged diameter to close contact an inner diameter surface of the end portion having an enlarged diameter and an external diameter surface of the inserted end portion.

A diameter of an end portion of any one of the connecting portion 10 and the refrigerant pipe 20 may be enlarged, and a diameter of an end portion of the other one may be reduced. The exemplary embodiments will be described as follows.

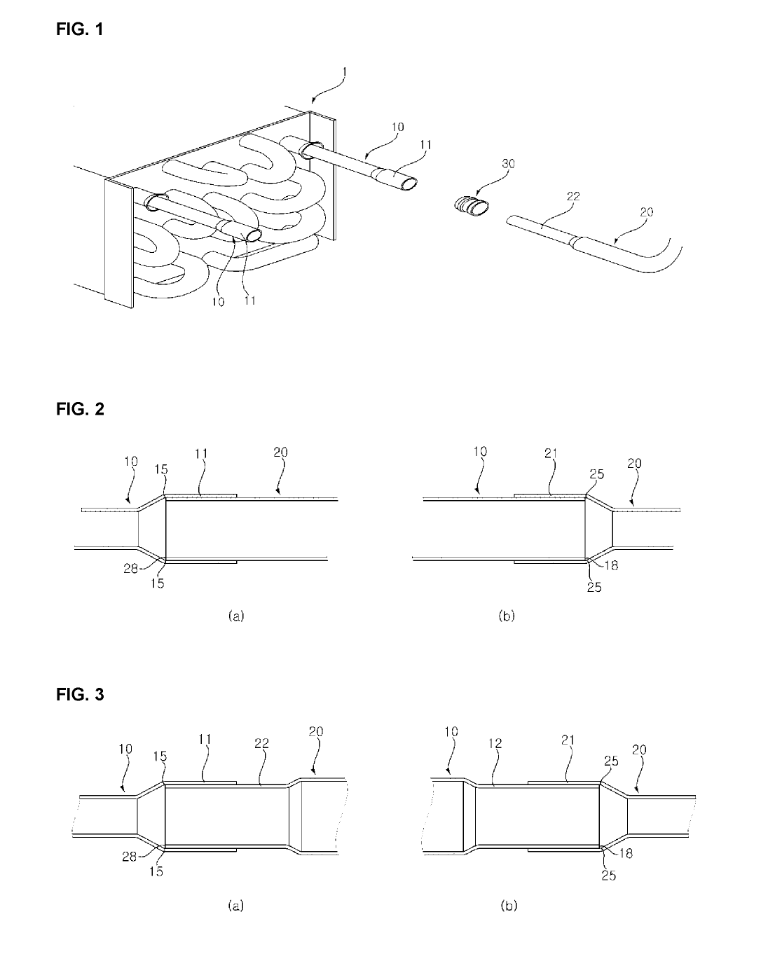

In an exemplary embodiment (see FIG. 2A), a diameter of an end portion 11 of the connecting portion may be enlarged, and at an inner diameter surface thereof, the arriving portion 15 may be formed. An end portion of the refrigerant pipe may be inserted into the end portion 11 of the connecting portion. The end 28 of the refrigerant pipe is latched to and received in the arriving portion 15 of the connecting portion.

In another exemplary embodiment (see FIG. 2B), a diameter of an end portion 21 of the refrigerant pipe may be enlarged, and at an inner diameter surface thereof, the arriving portion 25 may be formed. An end portion of the connecting portion may be inserted into the end portion 21 of the refrigerant pipe. The end 18 of the connecting portion is latched to and received in the arriving portion 15 of the refrigerant pipe.

In yet another exemplary embodiment (see FIG. 3A), a diameter of the end portion 11 of the connecting portion may be enlarged, and at an inner diameter surface thereof, the arriving portion 15 may be formed. A diameter of an end portion 22 of the refrigerant pipe may be reduced and inserted into the end portion 11 of the connecting portion. The end 28 of the refrigerant pipe may be latched to and received in the arriving portion 15 of the connecting portion.

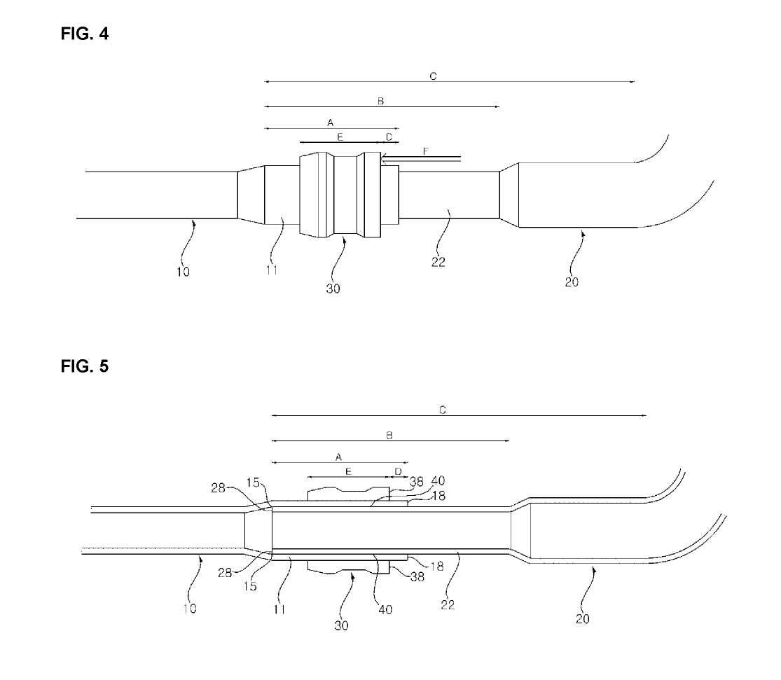

In still another exemplary embodiment (see FIG. 4B), a diameter of the end portion 21 of the refrigerant pipe may be enlarged and at an inner diameter surface thereof, the arriving portion 25 may be formed. A diameter of an end portion 12 of the connecting portion may be reduced and inserted into the end portion 21 of the refrigerant pipe. The end 18 of the connecting portion may be latched to and received in the arriving portion 25 of the refrigerant pipe.

In the exemplary embodiments, because the arriving portions 15 and 25 are formed at an inner diameter surface of any one of the connecting portion 10 and the refrigerant pipe 20, the ends 18 and 28 of the other of the connecting portion 10 and the refrigerant pipe 20 may be latched to the arriving portions 15 and 25 and received at the same location. A length of a segment in which the connecting portion 10 and the refrigerant pipe 20 are overlapped may become uniform in a predetermined length A. Thereby, by uniformly applying the predetermined length A, which is an insertion length requiring in a product to an entire product, the product may be easily produced.

The predetermined length A should have an enough length to maintain air-tightness of a close contact surface 40 of the connecting portion 10 and the refrigerant pipe 20, and for cost reduction and production convenience, the predetermined length A should be limited to a preferable length. Further, it may be preferable to form the predetermined length A longer than a length E of the lock ring 30. In an exemplary embodiment, the predetermined length A may be about 10 to 15 mm, and in such a numerical value range, air-tightness of the connection portion may be remarkably increased, and a refrigerant leakage inferiority rate may be remarkably reduced.

In other exemplary embodiments, a diameter of end portions 22 and 12 of a range from the end of the inserted other one to the predetermined length B larger than the predetermined length A may be reduced. Another exemplary embodiment will be described in detail with reference to FIGS. 4 and 5. A description of the exemplary embodiment may be applied to correspond in another exemplary embodiment.

Referring to FIGS. 4 to 6, an assembly process of the connecting portion 10, the refrigerant pipe 20, and the lock ring 30 will be described in detail. A first step of inserting the lock ring 30 into the end portion 22 in which a diameter of the refrigerant pipe is reduced may be performed. In this case, because a diameter of the end portion 22 of the refrigerant pipe is reduced, a gap may exist between an inner diameter surface of the lock ring 30 and an external diameter surface of the end portion 22 of the refrigerant pipe.

A second step of inserting the end portion 22 of the refrigerant pipe into the end portion 11 having an enlarged diameter of the connecting portion may be performed. In this case, the end 28 of the refrigerant pipe may be inserted until being latched to an arriving portion 15 of the connecting portion.

A third step of pushing the lock ring 30 in an end portion direction F of the connecting portion using an instrument such as a hydraulic pressure tool may be performed. Before pushing the lock ring 30, because an inner diameter of the lock ring 30 is a little smaller than an outer diameter of the end portion 11 of the connecting portion, when pushing the lock ring 30, the end portion 11 of the connecting portion and the end portion 22 of the refrigerant pipe may be in close contact while being changed.

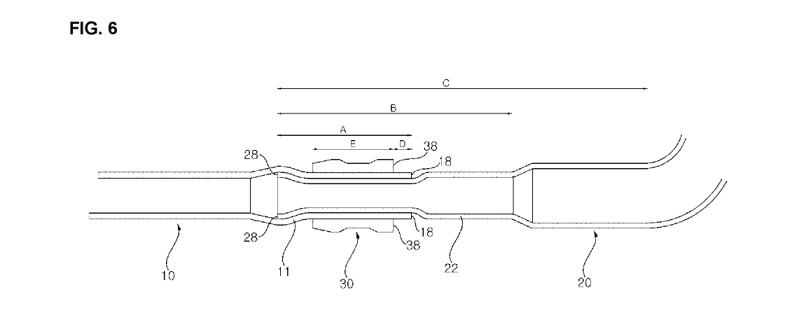

Referring to FIG. 6 in which the change is exaggeratedly shown, at the third step, an inner diameter surface of the lock ring 30 may press an external diameter surface of the end portion 11 of the connecting portion. Accordingly, an inner diameter surface of the end portion 11 of the connecting portion may press an external diameter surface of the end portion 22 of the refrigerant pipe. The end portion 11 of the connecting portion and the end portion 22 of the refrigerant pipe may be elastic deformed or ductile deformed toward a center axis of the refrigerant pipe 20 by such pressing, and a close contact surface of two end portions 11 and 22 may become further airtight.

By reducing a diameter of the end portion 22 of the refrigerant pipe by the predetermined length B, a level that enlarges a diameter of the end portion 11 of the connecting portion may be reduced. This is because as an external diameter of the end portion 22 of the refrigerant pipe reduces, a size of a necessary inner diameter of the end portion 11 of the connecting portion may be together reduced.

The predetermined length B may be equal to or greater than a value in which a length E of the lock ring is added to the predetermined length A. This is because even at the second step, a gap may be maintained between an inner diameter surface of the lock ring 30 and an external diameter surface of the end portion 22 having a reduced diameter of the refrigerant pipe. At the second step, a portion in which the lock ring 30 is temporarily supported on the end portion 22 of the refrigerant pipe may be a remained portion after being inserted into the end portion 11 of the connecting portion among the end portion 22 of the refrigerant pipe. A length of the remained portion becomes a value B—A that subtracts the predetermined length A from the predetermined length B. When the value B—A is greater than or equal to the length E of the lock ring 30, a gap between an inner diameter surface of the lock ring 30 and an external diameter surface of the refrigerant pipe 20 may be maintained. As a result, even at the second step, by preventing a phenomenon in which an external diameter surface of the refrigerant pipe 20 is scratched by an inner diameter surface of the lock ring 30, durability of a product may be improved. In the present exemplary embodiment, a preferable predetermined length B may be about 25 to 30 mm.

Further, a reduction rate of a diameter of the end portion 22 of the refrigerant pipe may be determined to a predetermined rate. This is because when the diameter reduction rate is large, it may be difficult to maintain an inner diameter surface of the end portion 11 of the connecting portion and an external diameter surface of the end portion 22 of the refrigerant pipe in close contact, and when the diameter reduction rate is small, a gap between an inner diameter surface of the lock ring 30 and an external diameter surface of the end portion 22 of the refrigerant pipe may be reduced and thus a probability that the scratch phenomenon occurs increases.

In consideration of this, in the present exemplary embodiment, an external diameter of the end portion 22 of the refrigerant pipe may be reduced by 19 to 23%. When a diameter reduction rate is 23% or less, air-tightness of the connection portion may be remarkably enhanced, and when a diameter reduction rate is 19% or more, the scratch phenomenon may be remarkably reduced.

For the second step assembly process of pushing the lock ring 30 to the side, an instrument that pushes the lock ring 30 from the refrigerant pipe 20 in a direction F of the connecting portion 10 may be used. The instrument may include a fixing portion that holds and fixes a portion of the connecting portion 10 and a pressing portion that contacts an end portion 38 of the lock ring and that has a predetermined thickness and that pushes in a direction F of the fixing portion along the refrigerant pipe 20.

An operation track of the pressing portion may be of a direction F of the fixing portion along the refrigerant pipe 20. In order to prevent the operation track from being disturbed, a segment from the end 28 of the refrigerant pipe 20 to the predetermined length C may be straightly extended. When the refrigerant pipe 20 of a segment corresponding to the predetermined length C is bent, the pressing portion may be latched to a bent portion of the refrigerant pipe 20 and thus it may be difficult to secure a necessary operation track.

A predetermined length C may be larger than a value in which the length E of the lock ring 30 and a thickness of the pressing portion are added to the predetermined length A. At the second step, a segment from the end 28 of the refrigerant pipe to the predetermined length A may be a segment in which the connecting portion 10 and the refrigerant pipe 20 are overlapped, and a segment from the end 18 of the connecting portion to the length E of the lock ring may be a segment in which the lock ring is temporarily supported, and a segment from the end 38 of the lock ring to a thickness of the pressing portion may be a segment in which the pressing portion is located before operating by a contact with the end 38 of the lock ring. A length in which such three segments are added may be a minimum length of the predetermined length C. In the present exemplary embodiment, the predetermined length C may be about 60 mm or more.

At the third step, the lock ring 30 may be separately disposed by the predetermined length D from the end 18 of the connecting portion. In this way, by fully pushing and assembling the lock ring 30, air-tightness of the connection portion may be further increased.

The predetermined length D may be smaller than a value that subtracts the length E of the lock ring from the predetermined length A. Thereby, even while an entire portion of an inner diameter surface of the lock ring 30 presses an external diameter surface of the end portion 11 of the connecting portion, by fully pushing and assembling the lock ring 30, air-tightness of the close contact surface 40 may be increased.

Therefore, it may be preferable to limit the predetermined length D to a preferable range. In the present exemplary embodiment, the predetermined length D may be about 2 to 6 mm. In this numerical value range, air-tightness of the connection portion may be remarkably increased.

In the present exemplary embodiment, before the second step assembly process, a material having adhesion may be applied to at least one of an inner diameter surface of the end portion 11 of the connecting portion and an external diameter surface of the end portion 22 of the refrigerant pipe. The material having adhesion may be located at the close contact surface 40 and increases a bonding force of the end portion 11 of the connecting portion and the end portion 22 of the refrigerant pipe and air-tightness of the close contact surface 40.

Before the second step assembly process, a lubricant may be applied to at least one of an inner diameter surface of the end portion 11 of the connecting portion and an external diameter surface of the end portion 22 of the refrigerant pipe. Thereby, in an insertion process of the second step, a phenomenon in which the close contact surface 40 is scratched may be reduced. A material having adhesion may perform a lubricant function in an insertion process of the second step, and after an insertion process of the second step, the material may be hardened between the close contact surface 40 to perform an adhesive function.

A device for drying the laundry may enhance drying efficiency by maintaining an air heating performance and a condensation performance. A device for drying the laundry may improve user convenience by lowering a product inferiority rate. A device for drying the laundry may improve production convenience.

A device for drying the laundry may include a refrigerant pipe made of a first metal material (any one metal material) that injects a refrigerant into a heat exchanger or discharges a refrigerant from a heat exchanger and a heat exchanger having a pipe type connecting portion made of a second metal material (another metal material) different from the first metal material connected to the refrigerant pipe adds the following solving means.

A diameter of an end portion of a range from the end of any one of the connecting portion and the refrigerant pipe to a predetermined length A may be enlarged, and at an inner diameter surface thereof, arriving portions having a concavely obtuse angle may be formed. An end portion of the one of the connecting portion and the refrigerant pipe may be inserted into an end portion of the other one and thus the end of the other one may be latched to and arrived in the arriving portion. The device for drying the laundry includes a lock ring that encloses an external diameter surface of the end portion having an enlarged diameter and that presses to close contact an inner diameter surface of the end portion having an enlarged diameter and an external diameter surface of the inserted end portion.

A diameter of an end portion of a range from the end of the other one to a predetermined length B larger than the predetermined length A may be reduced. Preferably, the predetermined length B may be equal to or larger than a value in which a length of the lock ring E is added to the predetermined length A. In this case, an external diameter may be reduced in a predetermined rate.

Preferably, a segment from the end of the other one to the predetermined length C larger than a value in which a length E of the lock ring is added to the predetermined length A is straightly extended. The lock ring may be disposed separately from the end of an end portion having an enlarged diameter by a predetermined length D smaller than a value that subtracts a length E of the lock ring from the predetermined length A.

By maintaining an air heating performance and a condensation performance, dry efficiency of the device can be enhanced. By inserting an end portion of the other one into an enlarged diameter of an end portion of any one of the connecting portion and the refrigerant pipe and by pressing them with a lock ring, an inferiority rate in which a refrigerant is leaked in a connection portion can be lowered.

Further, by forming a range in which a diameter of an end portion of the one is enlarged to the predetermined length A and by enabling the end of the other one to be latched to an arriving portion, an insertion length becomes constant and thus uniformity of a product can be improved. By forming a diameter reduction range of an end portion of the other one in a predetermined length B and by forming a diameter reduction rate in a predetermined rate, when installing a lock ring, contact scratch of an external diameter surface of an end portion of the other one and an inner diameter surface of the lock ring is prevented and thus durability of a product can be improved.

By securing an operation distance of a necessary instrument when installing a lock ring by forming a straightly extended segment of the other one in a predetermined length C, production convenience of a product can be improved. By separately disposing the lock ring by the predetermined length D from the end, a refrigerant leakage possibility of a connection portion can be further reduced. Further, by applying a material having adhesion to a close contact surface, the close contact surface can be further air-tightly formed.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A device for drying laundry including a heat exchanger through which a refrigerant passes, the device comprising:
a refrigerant pipe that injects a refrigerant into the heat exchanger or discharges a refrigerant from the heat exchanger, wherein the heat exchanger has a pipe type connecting portion connected to the refrigerant pipe, and wherein a diameter of one of the connecting portion and the refrigerant pipe is enlarged from a first end to a predetermined length A to form an arriving portion, and a first end portion of the other one of the connecting portion and the refrigerant pipe is inserted into the arriving portion to be latched to the arriving portion, and
a lock ring that encloses an external diameter surface of the first end having the enlarged diameter and presses an inner diameter surface of the first end having the enlarged diameter and an outer diameter surface of the inserted first end portion together.

2. The device of claim 1, wherein the refrigerant pipe is made of a first metal material and the connecting portion is made of a second metal material different from the first metal material.

3. The device of claim 2, wherein the predetermined length A is 10 to 15 mm.

4. The device of claim 2, wherein the first end portion extends to a predetermined length B larger than the predetermined length A.

5. The device of claim 4, wherein the predetermined length B is larger than or equal to a length of the lock ring plus the predetermined length A.

6. The device of claim 4, wherein an external diameter of the first end portion is reduced by 19 to 23%.

7. The device of claim 2, wherein a segment from the first end portion to a predetermined length C is larger than a length of the lock ring plus the predetermined length A and extends in a straight line.

8. The device of claim 2, wherein the lock ring is pressed onto the enlarged diameter at a predetermined length D inward from the first end, and wherein the predetermined length D is smaller than a length of the lock ring subtracted from the predetermined length A.

9. The device of claim 8, wherein the predetermined length D is 2 to 6 mm.

10. The device of claim 2, wherein an adhesive material is applied to at least one of an inner diameter surface of the arriving portion and an external diameter surface of the first end portion.
